(19) United States
(12) Patent Application Publication
(10) Pub. No.: US 2025/0156727 A1
(43) Pub. Date: May 15, 2025

(54) MULTI-BRANCH NETWORK ARCHITECTURE SEARCHING SYSTEM AND METHOD

(71) Applicant: INDUSTRIAL TECHNOLOGY RESEARCH INSTITUTE, Hsinchu (TW)

(72) Inventors: Chih-Neng LIU, Tainan City (TW); Ming-Yu SHIH, Taoyuan City (TW)

(73) Assignee: INDUSTRIAL TECHNOLOGY RESEARCH INSTITUTE, Hsinchu (TW)

(21) Appl. No.: 18/421,577

(22) Filed: Jan. 24, 2024

(30) Foreign Application Priority Data
Nov. 10, 2023 (TW) 112143424

(51) Int. Cl. G06N 3/0985; G06N 3/04

(52) U.S. Cl. CPC G06N 3/0985; G06N 3/04

(57) ABSTRACT

A multi-branch network architecture searching method includes: obtaining a training dataset with a plurality of input data; obtaining block design elements for blocks, wherein the blocks forms an architecture of a neural network, and the blocks are configured to perform a feature extraction on the input data to generate an output data; for each hyperparameter of the neural network, obtaining at least one hyperparameter setting value; inputting the training dataset, block design elements, and the at least one hyperparameter setting value into a hyperparameter optimization algorithm to generate a hyperparameter combination, wherein the hyperparameter combination includes one of the at least one hyperparameter setting corresponding to each hyperparameter; executing the neural network based on the hyperparameter combination and inputting a test dataset to evaluate a model performance of the neural network; and outputting the hyperparameter combination when the model performance reaches a threshold.

### CROSS-REFERENCE TO RELATED APPLICATIONS

This non-provisional application claims priority under 35 U.S.C. § 119(a) on Patent Application No(s). 112143424 filed in Taiwan on Nov. 10, 2023, the entire contents of which are hereby incorporated by reference.

### BACKGROUND

### 1. Technical Field

The present disclosure relates to neural networks and network architecture search, particularly to a multi-branch network architecture searching system and method.

### 2. Related Art

Artificial Intelligence (AI) has been widely applied in various fields.

However, when applying AI in emerging application areas such as industrial defect detection, even expert AI professionals require a significant amount of time to design network architectures, data augmentation strategies, and related hyperparameter adjustments suitable for the specific domain. The entire process is time-consuming and labor-intensive. On the other hand, existing automatic machine learning network architecture search technologies demand substantial computational resources and still take a long time to complete, raising the barrier for small and medium-sized enterprises to adopt AI technology.

### SUMMARY

According to one or more embodiment of the present disclosure, a multi-branch network architecture searching method is applicable to an electronic device comprising a processor. The method includes: obtaining a training dataset, wherein the training dataset includes a plurality of input data; obtaining a plurality of block design elements for a plurality of blocks, wherein the plurality of blocks forms an architecture of a neural network, and the plurality of blocks are configured to perform a feature extraction on the plurality of input data to generate an output data for each of a plurality of hyperparameters of the neural network, obtaining at least one hyperparameter setting value; inputting the training dataset, the plurality of block design elements, and the at least one hyperparameter setting value into a hyperparameter optimization algorithm to generate a hyperparameter combination, wherein the hyperparameter combination includes one of the at least one hyperparameter setting value corresponding to each of the plurality of hyperparameters; executing the neural network based on the hyperparameter combination and inputting a test dataset to evaluate a model performance of the neural network; and outputting the hyperparameter combination when the model performance reaches a threshold

According to one or more embodiment of the present disclosure, a multi-branch network architecture searching system is applicable to an electronic device comprising a processor. The system includes an input module, a computing module, and a neural network module. The input module is configured to obtain a training dataset, a plurality of block design elements of a plurality of blocks, at least one hyperparameter setting value of each of a plurality of hyperparameters of a neural network, and a test dataset, wherein the training dataset includes a plurality of input data, the plurality of blocks forms an architecture of the neural network, the plurality of blocks is configured to perform a feature extraction on one of the plurality of input data to generate an output data The computing module is communicably connected to the input module, wherein the computing module is configured to execute a hyperparameter optimization algorithm according to the training dataset, the plurality of block design elements, and the at least one hyperparameter setting value to generate a hyperparameter combination, the hyperparameter combination comprises one of the at least one hyperparameter setting value corresponding to each of the plurality of hyperparameters. The neural network module is communicably connected to the input module and the computing module, wherein the neural network module is configured to execute a neural network based on the hyperparameter combination and input the test dataset to evaluate a model performance of the neural network, and the computing module is further configured to output the hyperparameter combination when the model performance reaches a threshold.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a multi-branch network architecture searching system according to an embodiment of the present disclosure;

FIG. 2 is an example of a multi-branch neural network architecture, and

FIG. 3 is a flowchart of the multi-branch network architecture searching method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

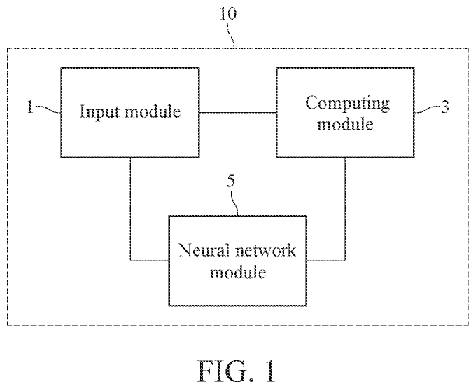

FIG. 1 is a block diagram of a multi-branch network architecture searching system according to an embodiment of the present disclosure. The system is applicable to an electronic device including a processor. As shown in FIG. 1, the multi-branch network architecture searching system 10 includes an input module 1, a computing module 3, and a neural network module 5.

The input module 1 is configured to obtain the training dataset, validation dataset, and test dataset of a neural network. These datasets each include a plurality of input data. When the neural network is applied to semiconductor defect detection, input data includes images of normal semiconductors and images of semiconductors with various defects. The Table 1 below provides an example of the experimental data used in the present disclosure, where the numbers represent the quantity of input data (images).

TABLE 1
Example of Semiconductor Defect Dataset

| | Training | Validation | Test | |
|---|---|---|---|---|
| Defect Type | Dataset | Dataset | Dataset | Total |
| Probe Mark Shift | 3473 | 212 | 422 | 4107 |
| Overkill | 213457 | 12462 | 25067 | 250986 |
| Ugly Die | 70249 | 4145 | 8259 | 82753 |
| Process Defect | 10625 | 640 | 1271 | 12536 |
| Particle | 42909 | 2513 | 5062 | 50484 |
| Foreign material | 49830 | 2974 | 5812 | 58616 |
| Pad discoloration | 1595 | 94 | 187 | 1876 |
| Sum-up | 392238 | 23040 | 46080 | 461358 |

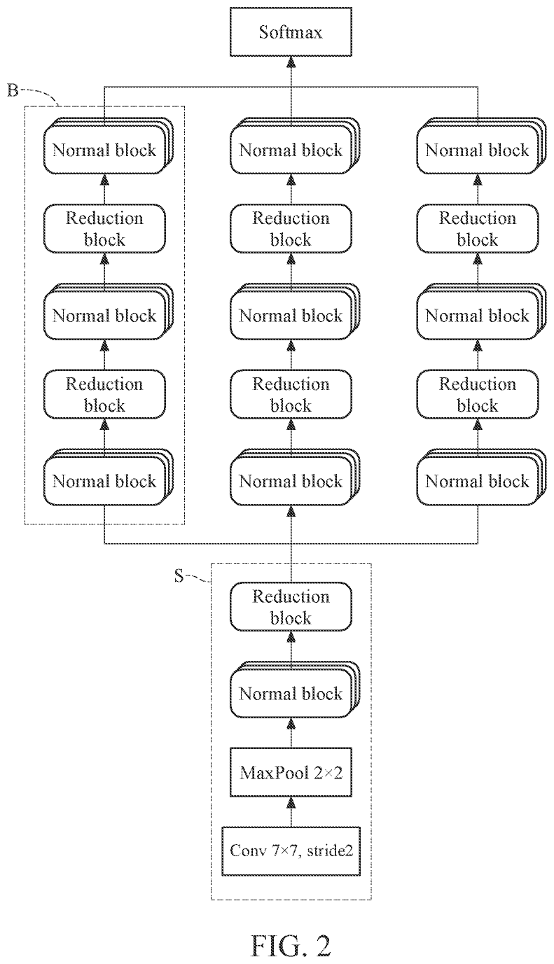

The input module 1 is further configured to obtain a plurality of block design elements of a plurality of blocks. The plurality of blocks is configured to perform a feature extraction on a feature map inputted to the blocks to generate an output data In an embodiment, the plurality of blocks includes normal blocks and reduction block. The plurality of blocks forms an architecture of the neural network. Components that may be used in normal blocks and reduction blocks include Conv 1×1, Conv 3×3, Conv 5×5, MaxPool 3×3, AvgPool 3×3, SepCony 3×3, SepConv 5×5, DilConv 3×3, DilConv 5×5, and others, but are not limited to the above. FIG. 2 is an example of a multi-branch neural network architecture. As shown in FIG. 2, the multi-branch neural network includes a stem S and three branches B, where the architecture except Conv7×7, stride 2, MaxPool 2×2, and Softmax are composed of blocks. The normal block is configured to preserve the dimension of the input feature map, while the reduction block is configured to reduce the dimension of the input feature map. In an embodiment, these blocks can be designed by AI engineers, or directly utilize residual blocks, NASNet, or the optimal blocks found by using Gradient-Based search methods, such as Pruning-Based Differentiable Architecture Search (PR-DARTS).

The neural network includes a plurality of hyperparameters. In an embodiment, these hyperparameters include at least one of the following: the number of blocks in the stem S, the number of channels in the stem S, the number of branches B, the number of blocks in each branch B, the number of channels in each branch B, and the position of the reduction block in the branch B. The input module 1 is further configured to obtain at least one hyperparameter setting value for each hyperparameter. All hyperparameter setting values constitute a search space. Table 2 below is an example of the search space, and this example can generate approximately 1.58 billion different model architectures.

TABLE 2
the example of the search space.

| | | # of |
|---|---|---|
| Hyperparameter Name | Value Feasible Set | Configs |
| the number of blocks in the stem | {2, 3, 4} | 3 |
| the number of channels in the stem | {16, 24, 32} | 3 |
| the number of branches | {1, 2, 3} | 3 |
| the number of blocks in each branch | {8, 11, 14, 17, 20} | 5 |
| the number of channels in each branch | {16, 24, 32, 40, 48, | 7 |
| | 56, 64} | |
| the position of the first reduction block | {0.1, 0.2, 0.3, 0.4} | 4 |
| the position of the second reduction block | {0.6, 0.7, 0.8, 0.9} | 4 |

Regarding the position of the reduction block, for example, if there are 11 blocks in a branch B, numbered from block 0 to block 10, and the position of reduction block 1 is set to 0.1, it means that the position of reduction block 1 is at block 1 (11*0.1=1.1, rounded to 1).

In an embodiment, the number of branches B is at least 1. Taking FIG. 2 as an example, the configuration value for the number of branches B is set to 3. The present disclosure does not limit the number of reduction blocks. In FIG. 2, for example, generally, in the neural network architecture, there are usually five reduction operations, with the stem S performing three of them and the branch B performing the remaining two. However, the present disclosure is not limited to these values.

Please refer to FIG. 1. The computing module 3 is communicably connected to the input module 1. The computing module 3 is configured to perform a hyperparameter optimization algorithm based on the search space constituted by the training dataset, block design elements, and hyperparameter setting values to generate a hyperparameter combination. In an embodiment, the hyperparameter optimization algorithm include at least one of the following: Tree-Structured Parzen Estimation, Bayesian Optimization, Grid Search, Random Optimization, Sequential Model-Based Algorithm Configuration, and Metis. The hyperparameter combination includes a hyperparameter setting value corresponding to each hyperparameter type. An example of a hyperparameter combination in FIG. 2 could be {2, 16, 1, 8, 16, 0.1, 0.6}. In other words, the hyperparameter combination includes one of the at least one hyperparameter setting value corresponding to each of the plurality of hyperparameters.

Please refer to FIG. 1. The neural network module 5 is communicably connected to the input module 1 and the computing module 3. The neural network module 5 is configured to execute the neural network based on the hyperparameter combination and inputs the test dataset to evaluate a model performance of the neural network. The computing module 3 is further configured to output the hyperparameter combination when the model performance reaches a threshold. In an embodiment, the model performance includes at least one of the following: model accuracy, false negative rate (FNR), true negative rate (TNR), parameter size, and inference speed.

In an embodiment, the implementations of the input module 1, the computing module 3, and the neural network module 5 are executed in the form of code or software on an electronic device. The electronic device may adopt at least one of the following examples: central processing unit (CPU), graphics processing unit (GPU), microcontroller (MCU), application processor (AP), field programmable gate array (FPGA), Application-Specific Integrated Circuit (ASIC), digital signal processor (DSP), system-on-a-chip (SOC), deep learning accelerator. However, the present disclosure is not limited to these examples.

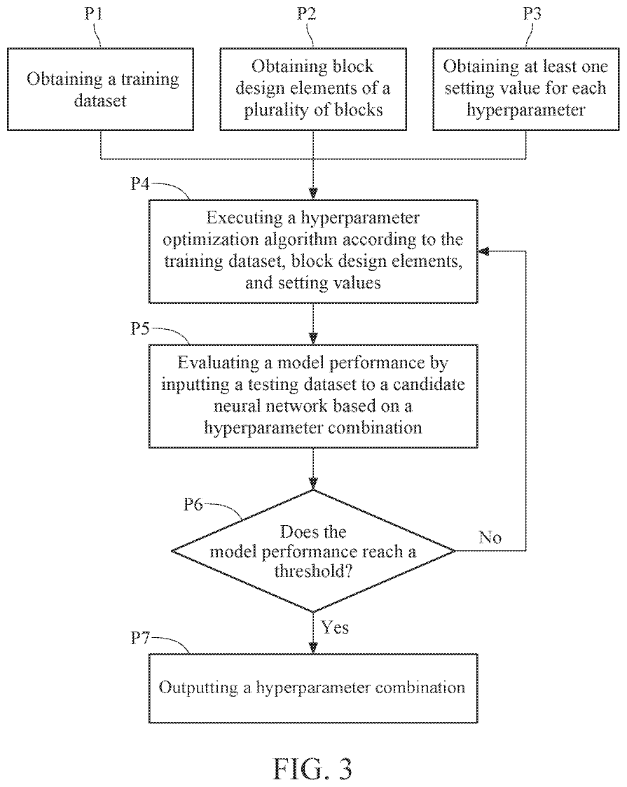

FIG. 3 is a flowchart of the multi-branch network architecture searching method according to an embodiment of the present disclosure. The method is applicable to an electronic device that includes a processor. As shown in FIG. 3, the multi-branch network architecture searching method includes steps P1 to P6.

In step P1, the input module 1 obtains the training dataset. In step P2, the input module 1 obtains the plurality of block design elements of the plurality of blocks. In step P3, the input module 1 obtains at least one hyperparameter setting value for each hyperparameter. In step P4, the computing module 3 executes a hyperparameter optimization algorithm according to the training dataset, the plurality of block design elements, and the hyperparameter setting values to generate a hyperparameter combination. In step P5, the neural network module 5 executes a candidate neural network based on the hyperparameter combination generated in step P4 and inputs the test dataset to evaluate a model performance of the candidate neural network.

In step P6, the computing module 3 determines whether the model performance reaches a threshold. If the determination is yes, the current hyperparameter combination used by the candidate neural network is output. If the determination is no, it returns to step P4, providing feedback on the model performance that did not reach the threshold to the hyperparameter optimization algorithm. Another hyperparameter combination is then generated by the hyperparameter optimization algorithm, and the process from step P4 to step P6 is repeated until the model performance of the candidate neural network reaches the threshold.

In summary, the multi-branch network architecture searching system and method proposed by the present disclosure parameterize the overall network architecture, using blocks as basic components, and employ a hyperparameter optimization algorithm for the search of the overall network architecture.

Existing network architecture search techniques often do not consider the search for the overall network architecture, especially in the case of multi-branch network architectures. The present disclosure focuses on neural networks with a multi-branch structure. Through experiments, it has been found that the best multi-branch structure model obtained in the manner of the present disclosure has a relative improvement of 6.7% in inference accuracy on the test dataset compared to manually designed neural network models. Additionally, the model parameter size is reduced by 79.5%, and the inference speed is relatively increased by 37%. Furthermore, compared to models without the use of multi-branch network architecture search techniques, the model discovered by the present disclosure shows a relative improvement of 13% in the test dataset's performance.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A multi-branch network architecture searching method, applicable to an electronic device comprising a processor, comprising:
obtaining a training dataset, wherein the training dataset includes a plurality of input data;
obtaining a plurality of block design elements for a plurality of blocks, wherein the plurality of blocks forms an architecture of a neural network, and the plurality of blocks are configured to perform a feature extraction on the plurality of input data to generate an output data;
for each of a plurality of hyperparameters of the neural network, obtaining at least one hyperparameter setting value;
inputting the training dataset, the plurality of block design elements, and the at least one hyperparameter setting value into a hyperparameter optimization algorithm to generate a hyperparameter combination, wherein the hyperparameter combination includes one of the at least one hyperparameter setting value corresponding to each of the plurality of hyperparameters;
executing the neural network based on the hyperparameter combination and inputting a test dataset to evaluate a model performance of the neural network; and
outputting the hyperparameter combination when the model performance reaches a threshold.

2. The multi-branch network architecture searching method of claim 1, wherein the plurality of blocks comprises a plurality of normal blocks and a plurality of reduction blocks, each of the plurality of normal blocks is configured to preserve a dimension of one of the plurality of input data, and each of the plurality of reduction blocks is configured to reduce the dimension of one of the plurality of input data.

3. The multi-branch network architecture searching method of claim 2, wherein the architecture of the neural network comprises a stem and at least one branch, and the plurality of hyperparameters of the neural network comprises at least one of the following: a number of blocks of the stem, a number of channels of the stem, a number of the at least one branch, a number of blocks of each of the at least one branch, a number of channels of each of the at least one branch, and a position of the plurality of reduction blocks of each of the at least one branch.

4. The multi-branch network architecture searching method of claim 3, wherein the number of the blocks of each of the at least one branch is at least one.

5. The multi-branch network architecture searching method of claim 1, wherein the hyperparameter optimization algorithm comprises at least one of the following: Tree-Structured Parzen Estimation, Bayesian Optimization, Grid Search, Random Optimization, Sequential Model-Based Algorithm Configuration, and Metis.

6. The multi-branch network architecture searching method of claim 1, wherein the model performance comprises at least one of the following: model accuracy, false negative rate (FNR), true negative rate (TNR), parameter size, and inference speed.

7. A multi-branch network architecture searching system applicable to an electronic device comprising a processor, comprising:
an input module configured to obtain a training dataset, a plurality of block design elements of a plurality of blocks, at least one hyperparameter setting value of each of a plurality of hyperparameters of a neural network, and a test dataset, wherein the training dataset includes a plurality of input data, the plurality of blocks forms an architecture of the neural network, the plurality of blocks is configured to perform a feature extraction on one of the plurality of input data to generate an output data.
a computing module communicably connected to the input module, wherein the computing module is configured to execute a hyperparameter optimization algorithm according to the training dataset, the plurality of block design elements, and the at least one hyperparameter setting value to generate a hyperparameter combination, the hyperparameter combination comprises one of the at least one hyperparameter setting value corresponding to each of the plurality of hyperparameters; and
a neural network module communicably connected to the input module and the computing module, wherein the neural network module is configured to execute a neural network based on the hyperparameter combination and input the test dataset to evaluate a model performance of the neural network, and the computing module is further configured to output the hyperparameter combination when the model performance reaches a threshold.

8. The multi-branch network architecture searching system of claim 7, wherein the plurality of blocks comprises a plurality of normal blocks and a plurality of reduction blocks, each of the plurality of normal blocks is configured to preserve a dimension of one of the plurality of input data, and each of the plurality of reduction blocks is configured to reduce the dimension of the plurality of input data.

9. The multi-branch network architecture searching system of claim 8, wherein the architecture of the neural network comprises a stem and at least one branch, and the plurality of hyperparameters of the neural network comprises at least one of the following: a number of blocks of the stem, a number of channels of the stem, a number of the at least one branch, a number of blocks of each of the at least one branch, a number of channels of each of the at least one branch, and a position of the plurality of reduction blocks of each of the at least one branch.

10. The multi-branch network architecture searching system of claim 9, wherein the number of blocks of each of the at least one branch is at least one.

11. The multi-branch network architecture searching system of claim 7, wherein the hyperparameter optimization algorithm comprises at least one of the following: Tree-Structured Parzen Estimation, Bayesian Optimization, Grid Search, Random Optimization, Sequential Model-Based Algorithm Configuration, and Metis.

12. The multi-branch network architecture searching system of claim 7, wherein the model performance comprises at least one of the following: model accuracy, false negative rate (FNR), true negative rate (TNR), parameter size, and inference speed.
